(19) United States
(12) Patent Application Publication
(10) Pub. No.: US 2020/0178073 A1
(43) Pub. Date: Jun. 4, 2020

(54) VEHICLE VIRTUAL ASSISTANCE SYSTEMS AND METHODS FOR PROCESSING AND DELIVERING A MESSAGE TO A RECIPIENT BASED ON A PRIVATE CONTENT OF THE MESSAGE

(71) Applicant: Toyota Motor North America, Inc., Plano, TX (US)

(72) Inventor: Jaya Bharath R. Goluguri, McKinney, TX (US)

(73) Assignee: Toyota Motor North America, Inc., Plano, TX (US)

(21) Appl. No.: 16/208,017

(22) Filed: Dec. 3, 2018

(51) Int. Cl. H04W 12/02; H04W 4/44; H04W 4/48

(52) U.S. Cl. CPC H04W 12/02; H04W 4/12; H04W 4/48; H04W 4/44

(57) ABSTRACT

A virtual assistance system for a vehicle includes one or more processors, one or more memory modules communicatively coupled to the one or more processors, network interface hardware capable of connecting to external networks and receiving messages from the external networks, one or more sensors for detecting one or more vehicle occupants, and machine readable instructions stored in the one or more memory modules that cause the virtual assistance system to perform at least the following when executed by the one or more processors: receive a message intended for a user, determine a number of occupants present in the vehicle, determine whether or not the message includes private content, and present the message to the user based on whether the message includes the private content and the number of occupants in the vehicle.

### TECHNICAL FIELD

Embodiments described herein generally relate to vehicle virtual assistance systems and, more specifically, to vehicle virtual assistance systems and methods for processing and delivering a message to a recipient based on a private content of the message.

### BACKGROUND

Occupants in a vehicle may receive messages such as text messages and/or voice messages. In some instances, the messages received may be private. However, a vehicle may carry multiple occupants. The message recipient may desire that some messages or particular message content remain private or that some content not be disclosed to particular passengers of the vehicle. Accordingly, vehicle virtual assistance systems and methods for processing and delivering a message to a recipient based on a private content of the message.

### SUMMARY

In one embodiment, a virtual assistance system for a vehicle includes one or more processors, one or more memory modules communicatively coupled to the one or more processors, network interface hardware capable of connecting to external networks and receiving messages from the external networks, one or more sensors for detecting one or more vehicle occupants, and machine readable instructions stored in the one or more memory modules that cause the virtual assistance system to perform at least the following when executed by the one or more processors: receive a message intended for a user, determine a number of occupants present in the vehicle, determine whether or not the message includes private content, and present the message to the user based on whether the message includes the private content and the number of occupants in the vehicle.

In another embodiment, a method for releasing a message to a user includes receiving the message intended for the user, determining a number of occupants present in a vehicle, determining whether or not the message includes private content, and presenting the message to the user based on whether the message includes the private content and the number of occupants in the vehicle.

In yet another embodiment, a vehicle including a virtual assistance system includes one or more processors, one or more memory modules communicatively coupled to the one or more processors, network interface hardware that is capable of receiving messages, one or more sensors for detecting one or more vehicle occupants, and machine readable instructions stored in the one or more memory modules that cause the virtual assistance system to perform at least the following when executed by the one or more processors: receive a message intended for a user, determine a number of occupants present in the vehicle, determine whether or not the message includes private content, and present the message to the user based on whether the message includes the private content and the number of occupants in the vehicle.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an interior portion of a vehicle for providing a vehicle virtual assistance system, according to one or more embodiments shown and described herein;

FIG. 2 schematically depicts a vehicle virtual assistance system, according to one or more embodiments shown and described herein;

FIG. 3 depicts a chart showing various message classification statuses based on private content and urgency of the message, according to one or more embodiments shown and described herein;

FIG. 4 depicts a flowchart for determining whether to deliver a message to a recipient based on a privacy classification of the message, according to one or more embodiments shown and described herein;

FIG. 5 depicts a hierarchy of message release states of the vehicle virtual assistance system based on vehicle occupancy, according to one or more embodiments shown and described herein; and

FIG. 6 depicts a flow chart for determining whether to deliver a message to a recipient based on vehicle occupancy, according to one or more embodiments shown and described herein.

### DETAILED DESCRIPTION

The embodiments disclosed herein include vehicle virtual assistance systems for processing and releasing a message to a recipient based on a privacy level of the message and the number and identity of the occupants within the vehicle. The vehicle virtual assistance system includes one or more processors, one or more memory modules communicatively coupled to the one or more processors, network interface hardware communicatively coupled to the one or more processors, an output device communicatively coupled to the one or more processors, and machine readable instructions stored in the one or more memory modules. The virtual assistance system receives, through the network interface hardware, a message from an external system, determines an occupancy status of the vehicle, determines an attention vulnerability status of the recipient, and releases the message to the recipient based on the occupancy status of the vehicle and the attention vulnerability status of the recipient. The various vehicle virtual assistance systems for processing and releasing a message to a recipient based on a classification level of the message and the occupancy status of the vehicle will be described in greater detail herein with specific reference to the corresponding drawings.

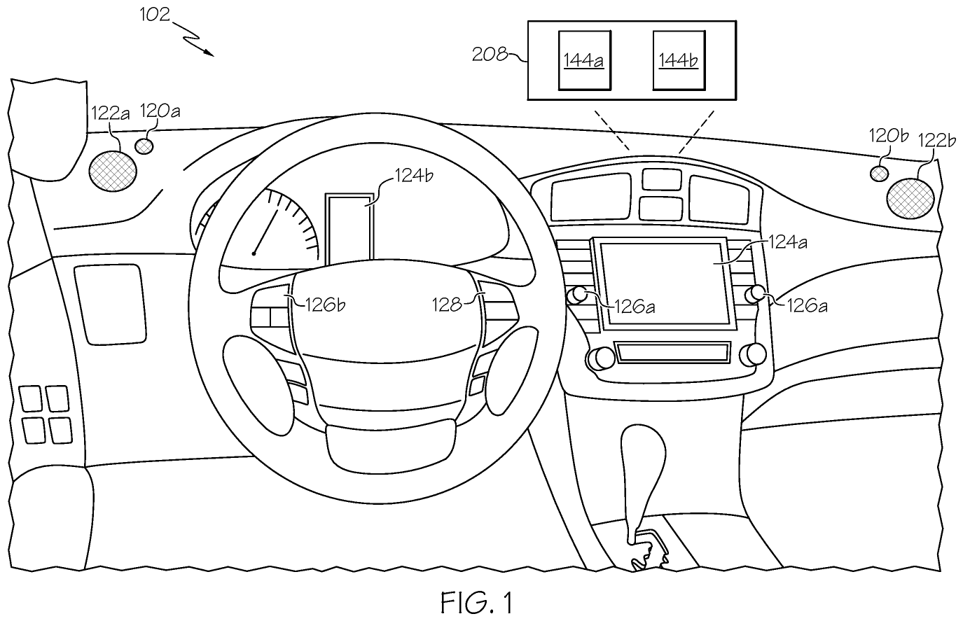

Referring now to the drawings, FIG. 1 schematically depicts an interior portion of a vehicle 102 for providing virtual assistance, according to embodiments disclosed herein. As illustrated, the vehicle 102 may include a number of components that may provide input to or output from the vehicle virtual assistance systems described herein. The interior portion of the vehicle 102 includes a console display 124a and a dash display 124b (referred to independently and/or collectively herein as “display 124”). The console display 124a may be configured to provide one or more user interfaces and may be configured as a touch screen and/or include other features for receiving user input. The dash display 124b may similarly be configured to provide one or more interfaces, but often the data provided in the dash display 124b is a subset of the data provided by the console display 124a. Regardless, at least a portion of the user interfaces depicted and described herein may be provided on either or both the console display 124a and the dash display 124b. The vehicle 102 also includes one or more microphones 120a, 120b (referred to independently and/or collectively herein as “microphone 120”) and one or more speakers 122a, 122b (referred to independently and/or collectively herein as “speaker 122”). The one or more microphones 120 may be configured for receiving user voice commands and/or other inputs to the vehicle virtual assistance systems described herein. Similarly, the speakers 122 may be utilized for providing audio content from the vehicle virtual assistance system to the user. The microphone 120, the speaker 122, and/or related components may be part of an in-vehicle audio system. The vehicle 102 also includes tactile input hardware 126a and/or peripheral tactile input hardware 126b for receiving tactile user input, as will be described in further detail below. The vehicle 102 also includes an activation switch 128 for providing an activation input to the vehicle virtual assistance system, as will be described in further detail below.

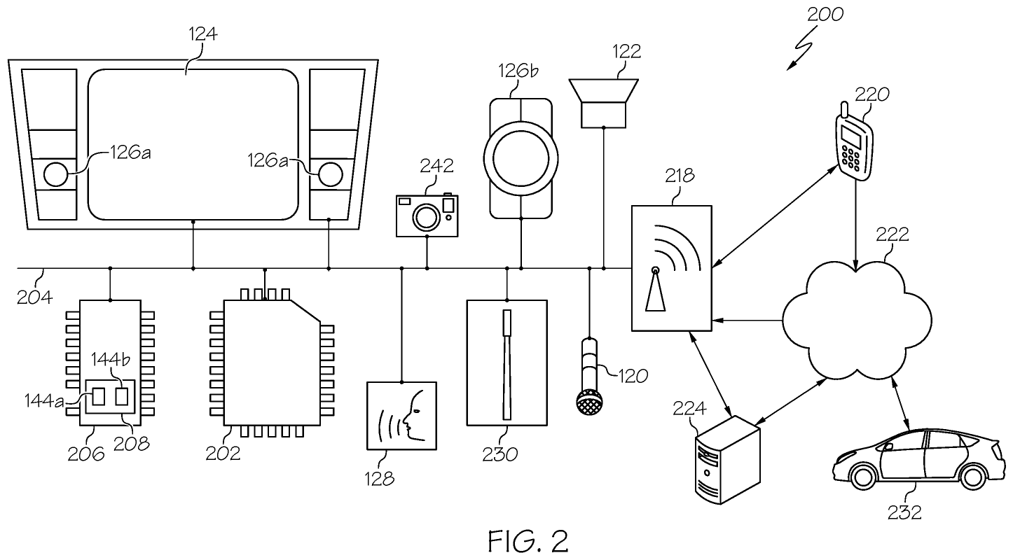

The vehicle 102 may also include a virtual assistance module 208, which stores message analysis logic 144a, and response analysis logic 144b. The message analysis logic 144a may include voice input analysis logic and the response analysis logic 144b may include a plurality of different pieces of logic, each of which may be embodied as a computer program, firmware, and/or hardware, as an example. The message analysis logic 144a may be configured to execute one or more language or vocabulary recognition algorithms message input received from one or more sources, such as the microphone 120, network interface hardware (FIG. 2), or a personal electronic device of a vehicle occupant, as will be described in further detail below. In some embodiments, the response analysis logic 144b may be configured to generate responses to message or speech input, such as by causing audible sequences to be output by the speaker 122 or causing imagery to be provided to the display 124, as will be described in further detail below.

Referring now to FIG. 2, an embodiment of a vehicle virtual assistance system 200, including a number of the components depicted in FIG. 1, is schematically depicted. It should be understood that the vehicle virtual assistance system 200 may be integrated within the vehicle 102 or may be embedded within a mobile device (e.g., smartphone, laptop computer, etc.) carried by an occupant of the vehicle.

The vehicle virtual assistance system 200 includes one or more processors 202, a communication path 204, one or more memory modules 206, a display 124, a speaker 122, tactile input hardware 126a, a peripheral tactile input hardware 126b, a microphone 120, an activation switch 128, a virtual assistance module 208, network interface hardware 218 (which may connect the vehicle virtual assistance system 200 to an external network or network node such as a server 224, a mobile device 220, or a second vehicle 232), a satellite antenna 230, and one or more cameras 242. The various components of the vehicle virtual assistance system 200 and the interaction thereof will be described in detail below.

As noted above, the vehicle virtual assistance system 200 includes the communication path 204. The communication path 204 may be formed from any medium that is capable of transmitting a signal such as, for example, conductive wires, conductive traces, optical waveguides, or the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Accordingly, the communication path 204 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. The communication path 204 communicatively couples the various components of the vehicle virtual assistance system 200. As used herein, the term “communicatively coupled” means that coupled components are capable of exchanging data signals with one another such as, for example, electrical signals via conductive medium, electromagnetic signals via air, optical signals via optical waveguides, and the like.

As noted above, the vehicle virtual assistance system 200 includes the one or more processors 202. Each of the one or more processors 202 may be any device capable of executing machine readable instructions. Accordingly, each of the one or more processors 202 may be a controller, an integrated circuit, a microchip, a computer, or any other computing device. The one or more processors 202 are communicatively coupled to the other components of the vehicle virtual assistance system 200 by the communication path 204. Accordingly, the communication path 204 may communicatively couple any number of processors with one another, and allow the modules coupled to the communication path 204 to operate in a distributed computing environment. Specifically, each of the modules may operate as a node that may send and/or receive data.

As noted above, the vehicle virtual assistance system 200 includes the one or more memory modules 206. Each of the one or more memory modules 206 of the vehicle virtual assistance system 200 is coupled to the communication path 204 and communicatively coupled to the one or more processors 202. The one or more memory modules 206 may comprise RAM, ROM, flash memories, hard drives, or any device capable of storing machine readable instructions such that the machine readable instructions may be accessed and executed by the one or more processors 202. The machine readable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable instructions and stored on the one or more memory modules 206. In some embodiments, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

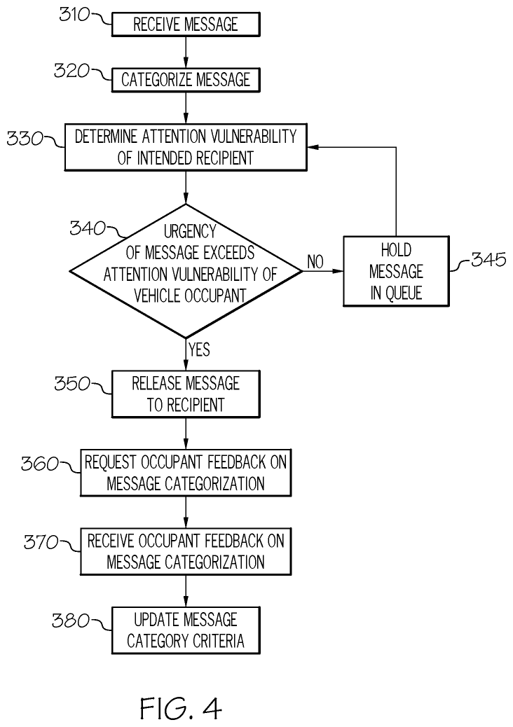

In embodiments, the one or more memory modules 206 include the virtual assistance module 208 which may process messages including spoken and written message data received from external networks (e.g., the server 224, the mobile device 220, or the second vehicle 232) and may deliver the message to an intended recipient (i.e., a vehicle occupant) based on private content of the message. Furthermore, the one or more memory modules 206 include machine readable instructions that, when executed by the one or more processors 202, cause the vehicle virtual assistance system 200 to perform the actions described below including the steps described in FIG. 4. The virtual assistance module 208 includes the message analysis logic 144a and response analysis logic 144b.

The message analysis logic 144a and response analysis logic 144b may be stored in the one or more memory modules 206. In embodiments, the message analysis logic 144a and response analysis logic 144b may be stored on, accessed by and/or executed on the one or more processors 202. In embodiments, the message analysis logic 144a and response analysis logic 144b may be executed on and/or distributed among other processing systems to which the one or more processors 202 are communicatively linked. For example, at least a portion of the message analysis logic 144a may be located onboard the vehicle 102. In one or more arrangements, a first portion of the message analysis logic 144a may be located onboard the vehicle 102, and a second portion of the message analysis logic 144a may be located remotely from the vehicle 102 (e.g., on a cloud-based server, or a remote computing system). In some embodiments, the message analysis logic 144a may be located remotely from the vehicle 102.

The message analysis logic 144a may be implemented as computer readable program code that, when executed by a processor, implements one or more of the message analysis-related processes described herein. In one or more arrangements, the message analysis logic 144a may include artificial or computational intelligence elements, e.g., neural network, fuzzy logic or other machine learning algorithms.

The message analysis logic 144a may receive one or more message inputs from one or more external networks such as an email or voicemail server, a text message server, or other message server. In some embodiments, the message inputs may include images, video, or sound data intended for one or more vehicle occupants.

The response analysis logic 144b may receive one or more occupant voice inputs from one or more vehicle occupants of the vehicle 102. The one or more occupant voice inputs may include any audial data spoken, uttered, pronounced, exclaimed, vocalized, verbalized, voiced, emitted, articulated, and/or stated aloud by a vehicle occupant. The one or more occupant voice inputs may include one or more letters, one or more words, one or more phrases, one or more sentences, one or more numbers, one or more expressions, and/or one or more paragraphs, etc.

The one or more occupant voice inputs may be sent to, provided to, and/or otherwise made accessible to the response analysis logic 144b. The response analysis logic 144b may be configured to analyze the occupant voice inputs. The response analysis logic 144b may analyze the occupant voice inputs in various ways. For example, the response analysis logic 144b may analyze the occupant voice inputs using any known natural language processing system or technique. Natural language processing may include analyzing each user's notes for topics of discussion, deep semantic relationships and keywords. Natural language processing may also include semantics detection and analysis and any other analysis of data including textual data and unstructured data. Semantic analysis may include deep and/or shallow semantic analysis. Natural language processing may also include discourse analysis, machine translation, morphological segmentation, named entity recognition, natural language understanding, optical character recognition, part-of-speech tagging, parsing, relationship extraction, sentence breaking, sentiment analysis, speech recognition, speech segmentation, topic segmentation, word segmentation, stemming and/or word sense disambiguation. Natural language processing may use stochastic, probabilistic and statistical methods. In some embodiments, the response analysis logic 144b may analyze the occupant voice inputs to identify the occupant. In some embodiments, the response analysis logic 144b may be used to analyze a response and to identify the occupants of the vehicle 102. For example, the response analysis logic 144b may compare the occupant voice inputs with samples associated with different users, and identify that the occupant voice inputs are comparable to a sample associated with a certain user.

The response analysis logic 144b may analyze the occupant voice inputs to determine whether one or more commands and/or one or more inquiries are included in the occupant voice inputs. A command may be any request to take an action and/or to perform a task, for example, to delay delivering a message to a vehicle occupant or to classify a message as containing private content. An inquiry includes any questions asked by a user. For example, a user may inquire whether a held message includes private content or not or whether a message contains a particular type of data or not (e.g., a string of numbers or particular words). The response analysis logic 144b may analyze the vehicle operational data in real-time or at a later time. As used herein, the term “real time” means a level of processing responsiveness that a user or system senses as sufficiently immediate for a particular process or determination to be made, or that enables the processor to keep up with some external process.

Still referring to FIG. 2, the vehicle virtual assistance system 200 comprises the display 124 for providing visual output such as, for example, messages and other information, entertainment, maps, navigation, information, or a combination thereof. The display 124 is coupled to the communication path 204 and communicatively coupled to the one or more processors 202. Accordingly, the communication path 204 communicatively couples the display 124 to other modules of the vehicle virtual assistance system 200. The display 124 may include any medium capable of transmitting an optical output such as, for example, a cathode ray tube, light emitting diodes, a liquid crystal display, a plasma display, or the like. Moreover, the display 124 may be a touchscreen that, in addition to providing optical information, detects the presence and location of a tactile input upon a surface of or adjacent to the display. Accordingly, each display may receive mechanical input directly upon the optical output provided by the display. Additionally, it is noted that the display 124 may include at least one of the one or more processors 202 and the one or memory modules 206. While the vehicle virtual assistance system 200 includes a display 124 in the embodiment depicted in FIG. 2, the vehicle virtual assistance system 200 may not include a display 124 in other embodiments, such as embodiments in which the vehicle virtual assistance system 200 provides exclusively audible feedback via the speaker 122.

As noted above, the vehicle virtual assistance system 200 includes the speaker 122 for transforming data signals from the vehicle virtual assistance system 200 into mechanical vibrations, such as in order to output audible prompts or audible information from the vehicle virtual assistance system 200. The speaker 122 is coupled to the communication path 204 and communicatively coupled to the one or more processors 202.

Still referring to FIG. 2, the vehicle virtual assistance system 200 comprises tactile input hardware 126a coupled to the communication path 204 such that the communication path 204 communicatively couples the tactile input hardware 126a to other modules of the vehicle virtual assistance system 200. The tactile input hardware 126a may be any device capable of transforming mechanical, optical, or electrical signals into a data signal capable of being transmitted with the communication path 204. Specifically, the tactile input hardware 126a may include any number of movable objects that each transform physical motion into a data signal that may be transmitted to over the communication path 204 such as, for example, a button, a switch, a knob, a microphone or the like. In some embodiments, the display 124 and the tactile input hardware 126a are combined as a single module and operate as an audio head unit or an infotainment system. However, it is noted, that the display 124 and the tactile input hardware 126a may be separate from one another and operate as a single module by exchanging signals via the communication path 204. While the vehicle virtual assistance system 200 includes tactile input hardware 126a in the embodiment depicted in FIG. 2, the vehicle virtual assistance system 200 may not include tactile input hardware 126a in other embodiments, such as embodiments that do not include the display 124.

As noted above, the vehicle virtual assistance system 200 optionally includes the peripheral tactile input hardware 126b coupled to the communication path 204 such that the communication path 204 communicatively couples the peripheral tactile input hardware 126b to other modules of the vehicle virtual assistance system 200. For example, in one embodiment, the peripheral tactile input hardware 126b is located in a vehicle console to provide an additional location for receiving input. The peripheral tactile input hardware 126b operates in a manner substantially similar to the tactile input hardware 126a, i.e., the peripheral tactile input hardware 126b includes movable objects and transforms motion of the movable objects into a data signal that may be transmitted over the communication path 204.

As noted above, the vehicle virtual assistance system 200 comprises the microphone 120 for transforming acoustic vibrations received by the microphone 120 into a speech input signal. The microphone 120 is coupled to the communication path 204 and communicatively coupled to the one or more processors 202. As will be described in further detail below, the one or more processors 202 may process the speech input signals received from the microphone 120 and/or extract speech information from such signals.

Still referring to FIG. 2, the vehicle virtual assistance system 200 comprises the activation switch 128 for activating or interacting with the vehicle virtual assistance system 200. In some embodiments, the activation switch 128 is an electrical switch that generates an activation signal when depressed, such as when the activation switch 128 is depressed by a user when the user desires to utilize or interact with the vehicle virtual assistance system 200. In some embodiments, the vehicle virtual assistance system 200 does not include the activation switch. Instead, when a user says a certain word (e.g., “Roxy”), the vehicle virtual assistance system 200 becomes ready to recognize words spoken by the user.

As noted above, the vehicle virtual assistance system 200 includes the network interface hardware 218 for communicatively coupling the vehicle virtual assistance system 200 with a mobile device 220 or server 224 or an external computer network. The network interface hardware 218 is coupled to the communication path 204 such that the communication path 204 communicatively couples the network interface hardware 218 to other modules of the vehicle virtual assistance system 200. The network interface hardware 218 may be any device capable of transmitting and/or receiving data via a wireless network. Accordingly, the network interface hardware 218 may include a communication transceiver for sending and/or receiving data according to any wireless communication standard. For example, the network interface hardware 218 may include a chipset (e.g., antenna, processors, machine readable instructions, etc.) to communicate over wireless computer networks such as, for example, wireless fidelity (Wi-Fi), WiMax, Bluetooth, IrDA, Wireless USB, Z-Wave, ZigBee, or the like. In some embodiments, the network interface hardware 218 includes a Bluetooth transceiver that enables the vehicle virtual assistance system 200 to exchange information with the mobile device 220 (e.g., a smartphone) via Bluetooth communication.

Still referring to FIG. 2, data from various applications running on the mobile device 220 may be provided from the mobile device 220 to the vehicle virtual assistance system 200 via the network interface hardware 218. The mobile device 220 may be any device having hardware (e.g., chipsets, processors, memory, etc.) for communicatively coupling with the network interface hardware 218 and any type of external network, such as a cellular network 222. The mobile device 220 may include an antenna for communicating over one or more of the wireless computer networks described above. Moreover, the mobile device 220 may include a mobile antenna for communicating with the cellular network 222. Accordingly, the mobile antenna may be configured to send and receive data according to a mobile telecommunication standard of any generation (e.g., 1G, 2G, 3G, 4G, 5G, etc.). Specific examples of the mobile device 220 include, but are not limited to, smart phones, tablet devices, e-readers, laptop computers, or the like.

The cellular network 222 generally includes a plurality of base stations that are configured to receive and transmit data according to mobile telecommunication standards. The base stations are further configured to receive and transmit data over wired systems such as public switched telephone network (PSTN) and backhaul networks. The cellular network 222 may further include any network accessible via the backhaul networks such as, for example, wide area networks, metropolitan area networks, the Internet, satellite networks, or the like. Thus, the base stations generally include one or more antennas, transceivers, and processors that execute machine readable instructions to exchange data over various wired and/or wireless networks.

Accordingly, the cellular network 222 may be utilized as a wireless access point by the network interface hardware 218 or the mobile device 220 to access one or more servers (e.g., a server 224). The server 224 generally includes processors, memory, and chipset for delivering resources via the cellular network 222. Resources may include providing, for example, processing, storage, software, and information from the server 224 to the vehicle virtual assistance system 200 via the cellular network 222. In some embodiments, the network interface hardware 218 may connect directly with the server 224.

Still referring to FIG. 2, the one or more servers accessible by the vehicle virtual assistance system 200 via the communication link of the mobile device 220 to the cellular network 222 or the server 224 may include third party servers that provide additional message analysis and speech recognition capability. For example, the server 224 may include message analysis and speech recognition algorithms capable of recognizing and interpreting more words, sounds, and images including messages than the local message analysis and speech recognition algorithms stored in the one or more memory modules 206. It should be understood that the network interface hardware 218 or the mobile device 220 may be communicatively coupled to any number of servers by way of the cellular network 222.

As noted above, the vehicle virtual assistance system 200 optionally includes a satellite antenna 230 coupled to the communication path 204 such that the communication path 204 communicatively couples the satellite antenna 230 to other modules of the vehicle virtual assistance system 200. The satellite antenna 230 is configured to receive signals from global positioning system satellites. Specifically, in one embodiment, the satellite antenna 230 includes one or more conductive elements that interact with electromagnetic signals transmitted by global positioning system satellites. The received signal is transformed into a data signal indicative of the location (e.g., latitude and longitude) of the satellite antenna 230 or an object positioned near the satellite antenna 230, by the one or more processors 202.

Additionally, it is noted that the satellite antenna 230 may include at least one of the one or more processors 202 and the one or memory modules 206. In embodiments where the vehicle virtual assistance system 200 is coupled to a vehicle, the one or more processors 202 execute machine readable instructions to transform the global positioning satellite signals received by the satellite antenna 230 into data indicative of the current location of the vehicle. While the vehicle virtual assistance system 200 includes the satellite antenna 230 in the embodiment depicted in FIG. 2, the vehicle virtual assistance system 200 may not include the satellite antenna 230 in other embodiments, such as embodiments in which the vehicle virtual assistance system 200 does not utilize global positioning satellite information or embodiments in which the vehicle virtual assistance system 200 obtains global positioning satellite information from the mobile device 220 via the network interface hardware 218.

Still referring to FIG. 2, it should be understood that the vehicle virtual assistance system 200 may be formed from a plurality of modular units, i.e., the display 124, the speaker 122, tactile input hardware 126a, the peripheral tactile input hardware 126b, the microphone 120, the activation switch 128, etc. may be formed as modules that when communicatively coupled form the vehicle virtual assistance system 200. Accordingly, in some embodiments, each of the modules may include at least one of the one or more processors 202 and/or the one or more memory modules 206. Accordingly, it is noted that, while specific modules may be described herein as including a processor and/or a memory module, the embodiments described herein may be implemented with the processors and memory modules distributed throughout various communicatively coupled modules.

Still referring to FIG. 2, the vehicle virtual assistance system 200 may further comprise one or more cameras 242. Each of the one or more cameras 242 is coupled to the communication path 204 and communicatively coupled to the one or more processors 202. Each of the one or more cameras 242 may be any device having an array of sensing devices capable of detecting radiation in an ultraviolet wavelength band, a visible light wavelength band, or an infrared wavelength band. Each of the one or more cameras 242 may have any resolution. The one or more cameras 242 may include an omni-directional camera, or a panoramic camera. In some embodiments, one or more optical components, such as a mirror, fish-eye lens, or any other type of lens may be optically coupled to at least one of the one or more cameras 242. The one or more cameras 242 may be used to capture an image of a seat arrangement inside the vehicle. The one or more cameras 242 may be located inside the vehicle to capture image data of the occupants in the vehicle and the image data may be used to identify the occupants of the vehicle.

In operation, the cameras 242 capture image data and communicate the image data to the vehicle virtual assistance system 200 and/or to other systems communicatively coupled to the communication path 204. The image data may be received by the processors 202, which may process the image data using one or more image processing algorithms. Any known or yet-to-be developed video and image processing algorithms may be applied to the image data in order to identify an item, situation, or person. Example video and image processing algorithms include, but are not limited to, kernel-based tracking (such as, for example, mean-shift tracking) and contour processing algorithms. In general, video and image processing algorithms may detect objects and movement from sequential or individual frames of image data. One or more object recognition algorithms may be applied to the image data to extract objects and determine their relative locations to each other. Any known or yet-to-be-developed object recognition algorithms may be used to extract the objects or even optical characters and images from the image data. Example object recognition algorithms include, but are not limited to, scale-invariant feature transform (“SIFT”), speeded up robust features (“SURF”), and edge-detection algorithms. In some embodiments, image data including images of the occupants of the vehicle is processed to determine an identity of the occupant as described in greater detail herein. For example, camera-captured biometrics (facial recognition technology, finger print scanning, eye scanning, etc.) may be utilized to identify and/or authenticate the identity of an occupant of the vehicle.

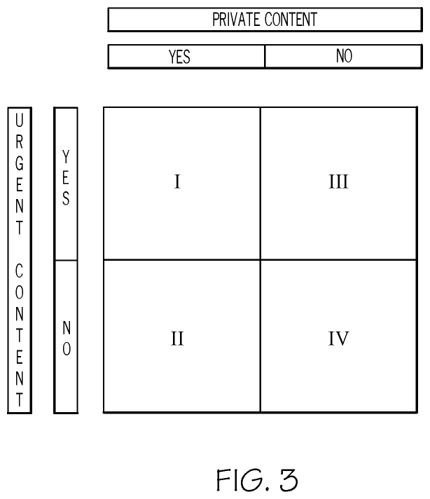

FIG. 3 depicts a hierarchy of message release states of the vehicle virtual assistance system 200 based on private content of the vehicle and FIG. 4 depicts a flowchart for determining whether or not to release a message to a recipient based on a categorization of the message. Referring to FIGS. 3 and 4, in block 310, the vehicle virtual assistance system 200 receives, through the network interface hardware 218, a message from an external system, for example, the server 224, the cellular network 222, or a mobile device 220. The vehicle virtual assistance system 200 may receive, for example, a text message from an SMS system or other type of messaging system such as an email server. In embodiments, the received message may be a voice message. In embodiments, the message may be one or more images, videos, or audio messages. For example, the vehicle virtual assistance system 200 may receive a message from an external source that says, “How's your day?” The vehicle virtual assistance system 200 may then proceed to process the message according to one or more steps described herein.

In block 320, the vehicle virtual assistance system 200 may categorize the message. To categorize the message, the vehicle virtual assistance system may run message analysis logic 144a on the message. The message analysis logic may analyze the message content for both urgency and private content. Referring to FIG. 3, the message may be categorized into one of four categories: (I) containing both urgent and private content, (II) containing private content but no urgent content, (III) containing urgent content but no private content, (IV) containing neither urgent content nor private content. The message analysis logic 144a may be configured to analyze the entire content of the message or to search only for what has previously been defined as private content and/or as urgent content.

The vehicle virtual assistance system 200 may assign an urgency classification to the message based on an urgency of the message. That is, the vehicle virtual assistance system 200 may categorize the message as an urgent message or as a non-urgent message. In some embodiments, the vehicle virtual assistance system 200 may assign a likelihood that the message is urgent based on a comparison with messages previously classified as urgent or non-urgent. More specifically, if the message is not classified as urgent or non-urgent, it is classified as probably urgent or possibly urgent. For example, one message may be analyzed and understood to include content that such as, “Call me immediately, I need to go to the emergency room.” This message may be classified as urgent. Another exemplary message may include content stating, “Have you seen the Nationals record? They are on a hot streak!” Such a message may be classified as non-urgent. Another message may state, “BuyBuyBaby is having a sale on diapers and you need to get there before they sell out.” Such a message may be classified as possibly or probably urgent. Categorization of messages as urgent or not urgent is based on the user's history of classifying messages and user feedback as requested by the vehicle virtual assistance system 200 as described in greater detail herein.

Additionally, the vehicle virtual assistance system 200 may classify a message as containing private content or not. For example, the vehicle virtual assistance system 200 may analyze a message using the message analysis logic 144a and determine that the message includes, for example, private health data, a social security number, a credit card number, and/or other private data. In some embodiments, the message may be categorized as private if it includes the names of particular contacts in an address book or a contacts application in a smart phone of a particular user of the vehicle. In some embodiments, the message may be categorized as private if it includes sexual content, or swear words. It is to be understood that these are merely examples of private content and that any type of data may be categorized as private data based on a user input and/or feedback to the vehicle virtual assistance system 200.

Some embodiments of the vehicle virtual assistance system 200 may include additional categories of urgency that may be used to classify messages. For example, in some embodiments, messages may be classified as possibly urgent or probably urgent. The messages may be classified based on comparisons of the message content to historical message content and other data. The classification of messages into the additional message categories may be implemented according to the principles described herein.

In block 330, the vehicle virtual assistance system 200 may determine an attention vulnerability status of the intended recipient of the message. The attention vulnerability status of the vehicle occupant may be determined based on a number of factors both internal and external to the vehicle. For example, the attention vulnerability status may be based on the status of the intended recipient with respect to his or her role in the operation of the vehicle (i.e., is he or she a driver or a passenger?). In some embodiments, the attention vulnerability of the intended recipient may be determined based on a current operational situation of the vehicle. The current operational situation of the vehicle may generally refer to vehicular activities that the vehicle is currently engaged in (e.g., operating in reverse, accelerating to pass a neighboring vehicle, driving at a higher than average speed, etc.) and/or operating characteristics of the vehicle (e.g., speed, acceleration, location, systems status, etc.). The vehicle virtual assistance system 200 may determine whether to release the message to the driver and/or passengers of the vehicle based on the current operational situation. For example, if the vehicle virtual assistance system 200 determines that releasing the message to the driver and/or passengers of the vehicle would affect the attention of the driver and/or passengers of the vehicle negatively and prevent the driver and/or passengers from attending to one or more critical aspects of vehicle operation, the vehicle virtual assistance system 200 may determine to hold the message. Example critical aspects of vehicle operation may include, but are not limited to, driving above a certain speed, operating the vehicle in a reverse mode, operating the vehicle in a particular area (e.g., a school zone, etc.) as determined by a location system (e.g., the satellite antenna 230), and other scenarios in which particular driver attention may be required or desired. In such scenarios, the vehicle virtual assistance system 200 may determine to withhold the message from the intended recipient as described herein.

In some instances the vehicle virtual assistance system 200 may withhold a message from an intended recipient based on an attention vulnerability status of a different occupant of the vehicle. For example, if a message is received intended for a passenger of the vehicle but the attention of the driver of the vehicle is particularly vulnerable (as determined, for example, by image data captured by the cameras 242), the message may not be released until the driver's attention is less vulnerable regardless of the fact that the driver may not be an intended recipient of the message.

The attention vulnerability of an occupant may be determined using a number of sensors, for example the cameras 242. In some embodiments, other internal and external monitoring systems of the vehicle (e.g., systems associated with vehicle operation such as GPS, speedometer, transmission monitoring, etc.) may be used to determine the attention vulnerability of the vehicle occupants.

In block 340, the vehicle virtual assistance system 200 may compare the message category (I, II, III, or IV) to the attention vulnerability of one or more occupants of the vehicle (e.g., the driver). If the urgency of the message does not exceed the attention vulnerability of the occupant, the vehicle virtual assistance system 200 may wait to send the message to the recipient as shown at block 345. For example, if a message classified as type II or IV is received (i.e., containing no urgent content) the message may be held based on the attention vulnerability of the occupants of the vehicle. Accordingly, delivery of the message to the recipient may be delayed until such time as a more favorable comparison between the message classification and the attention vulnerability exists. The vehicle virtual assistance system 200 may periodically check the attention vulnerability of vehicle occupants in order to determine whether the held message may be released.

However, if the urgency of the message exceeds attention vulnerability, the message may be released to the recipient in block 350. Accordingly, the recipient may receive the message. For example, the message may be played over the speakers 122 of the vehicle and/or displayed on the display 124 within the passenger compartment of the vehicle. In some embodiments, the message may be pushed to a smart phone or other portable electronic device in possession of the recipient. For example, the message may be sent over a Bluetooth connection between the recipient's smart device and the vehicle.

In some embodiments, once the message is released and the user has received the message, in block 360, the vehicle virtual assistance system 200 may request feedback on the accuracy of the categorization of the message completed at block 320. The vehicle virtual assistance system 200 may request feedback as to the accuracy of the categorization in order to better categorize messages as urgent, non-urgent, or as possibly urgent or likely urgent. The vehicle virtual assistance system 200 may use this feedback to more accurately classify future messages as urgent, non-urgent, or in between. At block 370, the vehicle virtual assistance system 200 may receive user feedback on the message categorization. The vehicle virtual assistance system 200 may receive user feedback using any of the feedback mechanisms described herein. In some embodiments, the user feedback may be spoken by one or more vehicle occupants and the vehicle virtual assistance system 200 may capture the spoken feedback using the microphones 120 and use the response analysis logic 144b to analyze and process feedback data. The user feedback may, for example, describe the categorization of the message by the vehicle virtual assistance system 200 as accurate or inaccurate. Such feedback may be stored along with the message content and cause the vehicle virtual assistance system to more accurately classify messages. Accordingly, in block 380, the vehicle virtual assistance system 200 may update the message category criteria based on user feedback.

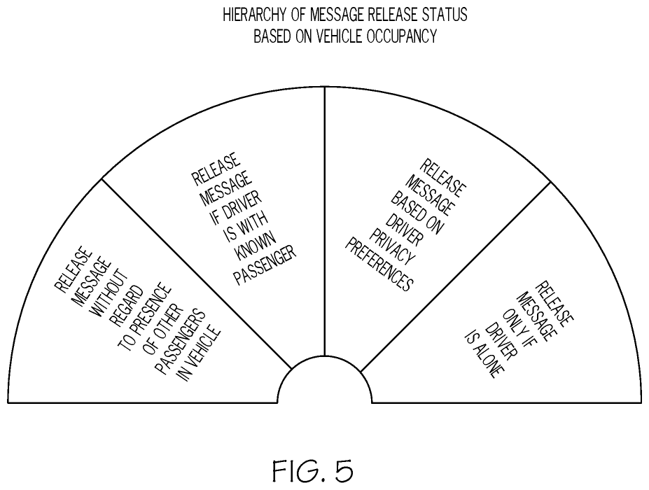

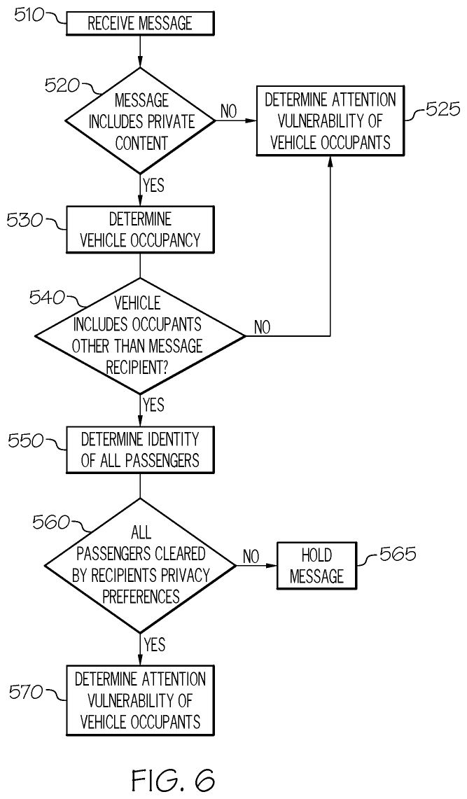

Referring now to FIGS. 5 and 6, a hierarchy of release states based on vehicle occupancy and one example method of releasing a message to a recipient based on vehicle occupancy is depicted. In FIG. 6, in block 510, the vehicle virtual assistance system 200 may receive a message that is intended for an occupant of the vehicle. In some embodiments, the vehicle virtual assistance system 200 may receive the message through a text message application, email application, voice mail application, video application, photo application, or other application of a smart phone or other personal electronic device of the intended recipient. For example, the vehicle virtual assistance system 200 may be communicatively coupled with a smart device or other personal electronic device of the message recipient using a Bluetooth connection. In addition to receiving the message, the vehicle virtual assistance system 200 may automatically determine an identity of the occupant based on a connection with the user of the personal electronic device.

The vehicle virtual assistance system 200 may receive the message from an external source, for example a smart phone or portable electronic device that is communicatively coupled to a message system such as SMS. The external message system may send the message to the vehicle and the vehicle may receive the message using, for example, the network interface hardware 218. In some embodiments, the vehicle virtual assistance system 200 may receive an email from an external email server. In some embodiments, the message is a voicemail, a video, an audio file, or an image.

In block 520, the vehicle virtual assistance system 200 examines the content of the message to determine whether or not the message includes private content. For example, the vehicle virtual assistance system 200 may perform one or more natural language processing algorithms or functions on the message as described above. Accordingly, the vehicle virtual assistance system 200 may determine whether or not the message contains private content. In some embodiments, the private content may include a social security number, a credit card number, a phone number, an email address, and other personally identifying information (“PII”) or other sensitive information that the recipient may desire to remain private. In some embodiments, the personal information may include healthcare information (e.g., examination records, appointment times, etc.) that the recipient desires to remain private. In some embodiments, the user may modify their privacy settings or preferences to classify other types of information as private information. The user may update their privacy preferences, for example, using an interface such as the display 140 or the microphone 120. It is to be understood that the personal information is not limited by the examples discussed herein and that users may modify their privacy settings such that the vehicle virtual assistance system 200 may hold up to all messages to a given recipient based on the recipient's privacy settings. In some embodiments, a message may be sent to a group of recipients one or more of whom may be inside the vehicle, and the message may be subjected to the processes described herein based on the privacy settings of the strictest recipient within the group.

Based on the content of the message (i.e., whether or not it includes private content), the message is either cleared to be sent to the occupants in the vehicle or not. In block 525, the message is determined to not include any private content. Accordingly, the message may be cleared for release to the intended recipient subject to an attention vulnerability of the vehicle occupants. For example, if the message is an audio file, the audio may be played over the speakers of the vehicle. If the message is a text, the message may be displayed on the display 124 and/or released to the recipient's smart phone or portable electronic device. In block 530, if the message does include private content, the vehicle virtual assistance system 200 may determine vehicle occupancy to determine whether or not the message may be released.

To determine vehicle occupancy, the vehicle virtual assistance system 200 may use one or more of the sensors described herein. For example, the vehicle virtual assistance system 200 may use data sensed by the cameras 242. The data received by the cameras 242 may be analyzed using facial recognition software or other software as described herein to determine the presence and the identity of users in the vehicle. Additionally, the microphone 120 may be used to capture audio data and the response analysis logic 144b may be used to recognize the speech or voice of vehicle occupants to determine the presence and identity of users in the vehicle as described herein. In some embodiments, weight sensors in seats may be used to determine the presence of vehicle occupants. In some embodiments, the presence of smart phones or other personal electronic devices associated with a particular user is used to determine the presence and to identify vehicle occupants. For example, if the driver and the passenger (e.g., a husband and wife) have each registered their smart phone with the vehicle, the presence of the smart phone of both the husband and the wife will allow the vehicle virtual assistance system 200 to determine that the husband and the wife are both present within the vehicle.

Once vehicle occupancy is determined, the vehicle virtual assistance system 200 determines whether or not the vehicle includes occupants besides the intended message recipient in block 540. If the vehicle does not include any occupant besides the message recipient, the message may be released to the recipient subject to the attention vulnerability of the vehicle occupant in block 545 as discussed in greater detail herein. If the vehicle includes occupants in addition to the message recipient, the vehicle virtual assistance system 200 may go through further verification of the identities of the vehicle occupants before releasing the message.

In block 550, the vehicle virtual assistance system 200 may determine the identities of the vehicle occupants besides the message recipient. The vehicle virtual assistance system 200 may use one or more of the identification methods described herein to determine the identity of the additional occupants of the vehicle. For example, the vehicle virtual assistance system 200 may use the cameras 242 to determine the identity of the vehicle occupants. In some embodiments, the identity of individual occupants is known based on a connection with a smart phone or other personal electronic device of the individual occupants.

In block 560, the vehicle virtual assistance system determines whether or not all of the passengers are cleared by the recipient's privacy preferences. The privacy preferences may be input or otherwise manipulated by a user of the vehicle virtual assistance system 200 through one or more interfaces of the vehicle virtual assistance system 200 as described in greater detail herein. If it is determined that all of the passengers in the vehicle are cleared by the recipient's privacy preferences, the message may be released to the recipient subject to the attention vulnerability of the vehicle occupants in block 570. If it is determined that all passengers are not cleared by recipient's privacy preferences, in block 565, the message may be held until such time as the message recipient actively clears the message for release him or herself or the occupancy of the vehicle is such that the message recipient's privacy preferences allow for release of the message.

In some embodiments, the vehicle virtual assistance system 200 may inform the message recipient that a message is waiting that will not be released. For example, the vehicle virtual assistance system 200 may generate a message delivery prompt and display and/or otherwise relay the message delivery prompt to the intended recipient of the message. The message delivery prompt may inform the intended recipient that a message has been received with him or her as at least one of the intended recipients. The message delivery prompt may offer the intended recipient an option to accept the message or to hold the message without betraying the messages content. In embodiments, the response of the intended recipient to the message delivery prompt may cause the vehicle virtual assistance system to update a user profile of the intended recipient. For example, if a user is offered a message delivery prompt indicating that a message has been received that includes potentially private content and the user is not alone in the vehicle, the vehicle virtual assistance system 200 may record the identities of the other occupants of the vehicle and may record the fact that the intended recipient did not mind if this private message content was overheard by the occupants of the vehicle at the time it was selectively released by the user. Based on this response, the vehicle virtual assistance system 200 may update the user privacy preferences of the recipient, its classification of the category of content contained in the message, or both such that in the future the vehicle virtual assistance system 200 is less likely to consider this type of message content as private content, such that the vehicle virtual assistance system 200 is more likely to send a message including this type of content to the intended recipient even if other passengers are present, or both. That is, the intended recipient's response to the message delivery prompt may be recorded and compared to the identities of the occupants of the vehicle to affect whether messages containing privacy content are displayed to these particular occupants in the future.

In some embodiments, the vehicle virtual assistance system 200 may inform the intended recipient that the message is not released based on the content of the message and the intended recipient's privacy preferences. In some embodiments, vehicle occupants can update their privacy preferences ahead of time such that the vehicle virtual assistance system 200 does not inform the user when he or she has a message waiting that is not released based on the content of the message.

It should now be understood that a vehicle virtual assistance systems for processing and releasing a message to a recipient may be used to release messages based on a privacy level of the message and an occupancy status of a vehicle. The vehicle virtual assistance system may include one or more processors, one or more memory modules communicatively coupled to the one or more processors, network interface hardware communicatively coupled to the one or more processors, an output device communicatively coupled to the one or more processors, and machine readable instructions stored in the one or more memory modules. The virtual assistance system receives, through the network interface hardware, a message from an external system, determines an occupancy status of the vehicle, determines an attention vulnerability status of the vehicle occupants, and releases the message to the recipient based on the occupancy status of the vehicle and the privacy content of the message.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A virtual assistance system for a vehicle, the virtual assistance system comprising:
one or more processors;
one or more memory modules communicatively coupled to the one or more processors;
network interface hardware capable of connecting to external networks and receiving messages from the external networks;
one or more sensors for detecting one or more vehicle occupants; and
machine readable instructions stored in the one or more memory modules that cause the virtual assistance system to perform at least the following when executed by the one or more processors:
receive a message intended for a user;
determine a number of occupants present in the vehicle;
determine an identity of an occupant of the vehicle;
assign an emergency classification to the message based on emergency category criteria:
determine whether or not the message includes private content;
present the message to the user based on whether the message includes the private content, the number of occupants in the vehicle, and the identity of the occupant of the vehicle;
receive feedback whether the emergency classification is correct; and
update the emergency category criteria based on the feedback.

2. The virtual assistance system of claim 1, further configured to:
determine an identity of each of the occupants of the vehicle; and
present the message to the user based on the identity of each of the occupants of the vehicle.

3. The virtual assistance system of claim 1, wherein the identity of the occupant of the vehicle is determined based on one or more images of the occupant.

4. The virtual assistance system of claim 1, wherein the identity of the occupant of the vehicle is determined based on a presence of a portable electronic device associated with an occupant within the vehicle.

5. The virtual assistance system of claim 1, wherein the machine readable instructions, when executed by the one or more processors, cause the virtual assistance system to withhold the message in response to a determination that the message includes private content and a determination that the number of occupants present in the vehicle is more than one.

6. The virtual assistance system of claim 1, wherein the virtual assistance system is configured to inform the user of messages that are received but are not released.

7. The virtual assistance system of claim 1 further configured to:
assign an emergency classification to the message based on an urgency of the message; and
release the message to the user based on a comparison between the urgency of the message and a current operational situation of the vehicle.

8. The virtual assistance system of claim 1, wherein:
the message is presented to the user on a display within the vehicle; and
the machine readable instructions, when executed by the one or more processors, cause the virtual assistance system to generate a message delivery prompt.

9. The virtual assistance system of claim 8, wherein the message delivery prompt includes information about the private content of the message.

10. The virtual assistance system of claim 9, wherein a response to the message delivery prompt is compared to identities of the occupants of the vehicle to affect whether messages containing the private content are displayed.

11. A method for releasing a message to a user, the method comprising:
receiving the message intended for the user;
determining a number of occupants present in a vehicle;
determining an identity of an occupant of the vehicle;
assigning an emergency classification to the message based on emergency category criteria:
determining whether or not the message includes private content;
presenting the message to the user based on whether the message includes the private content, the number of occupants in the vehicle, and the identity of the occupant of the vehicle;
receiving feedback whether the emergency classification is correct; and
updating the emergency category criteria based on the feedback.

12. The method of claim 11, further comprising:
determining an identity of each of the occupants of the vehicle; and
presenting the message to the user based on the identity of each of the occupants of the vehicle.

13. The method of claim 11, further comprising:
assigning an emergency classification to the message based on an urgency of the message; and
releasing the message to the user based on a comparison between the urgency of the message and a current operational situation of the vehicle.

14. The method of claim 11, wherein the identity of the occupant of the vehicle is determined based on one or more images of the occupant.

15. The method of claim 11, wherein the identity of the occupant of the vehicle is determined based on a presence of a smart phone or portable electronic device associated with an occupant within the vehicle.

16. The method of claim 11, further comprising holding the message in response to a determination that the message includes private content and in response to a determination of the number of occupants present in the vehicle.

17. The method of claim 11, further comprising informing the user of messages that are received but are not released.

18. The method of claim 11, further comprising:
generating a message delivery prompt; and
displaying the message on a display within the vehicle based on a response to the message delivery prompt.

19. A vehicle including a virtual assistance system comprising:
one or more processors;
one or more memory modules communicatively coupled to the one or more processors;
network interface hardware that is capable of receiving messages;
one or more sensors for detecting one or more vehicle occupants; and
machine readable instructions stored in the one or more memory modules that cause the virtual assistance system to perform at least the following when executed by the one or more processors:
receive a message intended for a user;
determine a number of occupants present in the vehicle;
determine an identity of an occupant of the vehicle;
assign an emergency classification to the message based on emergency category criteria:
determine whether or not the message includes private content;
present the message to the user based on whether the message includes the private content, the number of occupants in the vehicle, and the identity of the occupant of the vehicle;
receive feedback whether the emergency classification is correct; and
update the emergency category criteria based on the feedback.

20. The vehicle of claim 19 further configured to:
determine an identity of each of the occupants of the vehicle; and
present the message to the user based on the identity of each of the occupants of the vehicle.
